(19) United States
(12) Patent Application Publication
(10) Pub. No.: US 2025/0294278 A1
(43) Pub. Date: Sep. 18, 2025

(54) BLUETOOTH EARPHONE CASE

(71) Applicant: Chengyi Wang, Shenzhen (CN)

(72) Inventor: Chengyi Wang, Shenzhen (CN)

(21) Appl. No.: 19/226,626

(22) Filed: Jun. 3, 2025

(30) Foreign Application Priority Data
Jun. 6, 2024 (CN) 202410732618.0

(51) Int. Cl. H04R 1/02; H04R 1/10

(52) U.S. Cl. CPC H04R 1/028; H04R 1/1025; H04R 2201/025; H04R 2420/07

(57) ABSTRACT

A Bluetooth earphone case is provided, including an electronic control housing and two storage housings. A power supply assembly is disposed in the electronic control housing. Each storage housing is provided with one charging slot for placing a Bluetooth earphone, and the charging slot is internally provided with a charging contact matched with a charging port for charging the Bluetooth earphone. According to the provided Bluetooth earphone case, by using the design that the electronic control housing is independent of the two storage housings, an overall thickness of a case body is effectively reduced, so that the earphone case is more compact and easier to store and carry. The two charging slots can be mutually covered, and a flip cover structure required by a conventional Bluetooth earphone case is omitted, so that an overall structure is simplified.

### TECHNICAL FIELD

The present disclosure relates to the technical field of electronic equipment storage devices, and in particular, to a Bluetooth earphone case.

### BACKGROUND

A Bluetooth earphone case is designed to protect earphones and provide a convenient charging mode. In order to realize these functions, the earphone case must have enough space to accommodate the earphones and is provided with special charging contacts. Therefore, storage slots are indispensable parts in the design of the Bluetooth earphone case. In addition, in order to protect the earphones from being damaged by dust and impact, keep a case body tidy and attractive in appearance, a flip cover design emerges as required. When the case is closed, a closed space can be formed to ensure safety and privacy of the earphones.

With the development of Bluetooth earphone technologies, especially for some earphones of a high-end or professional type, a volume thereof is larger. This requires that the storage slots not only adapt to shapes of the earphones, but also need enough space to accommodate the earphones, and appropriate charging contacts are provided. Therefore, a large-sized Bluetooth earphone needs more space for accommodation, so as to ensure that a charging and protection requirement of the earphones is met.

Currently, storage slots of the Bluetooth earphone case on the market are arranged in the following manners:

A two-sided storage slot design: in this design, the accommodation slots are disposed on the two sides of the case body, and a stacked structure is usually used, which may provide stable support and charging contact for the earphones. However, this design increases an overall thickness of the case body and affects portability.

A same-sided storage slot design: to reduce the overall thickness of the case body, two adjacent storage slots are disposed on a same side. This design reduces the thickness, but increases a width of the case body and limits portability, especially when the earphone case needs to be placed in a narrow space.

Main technical problems of an existing design are as follows:
A contradiction between the portability and a space requirement: an existing double-sided or same-sided storage slot design meets an accommodation requirement for large-sized earphones, and sacrifices portability of the earphone case, especially in terms of increasing the thickness or the width of the case body.
Limitations of the flip cover design: a flip cover provides protection, but increases the complexity of the design, and may cause durability problems, such as damage or improper closing of the flip cover.

### SUMMARY

A technical problem to be solved by the present disclosure is to provide a Bluetooth earphone case with good portability and simple structure.

To solve the foregoing technical problem, a technical solution used in the present disclosure is as follows. A Bluetooth earphone case includes:
an electronic control housing, wherein a power supply assembly is disposed in the electronic control housing; and
two storage housings, wherein each storage housing is provided with one charging slot for placing a Bluetooth earphone, and the charging slot is internally provided with a charging contact matched with a charging port for charging the Bluetooth earphone;
the power supply assembly is electrically connected to the charging contact in the charging slot, so as to implement charging of the Bluetooth earphone;
the two storage housings are respectively hinged to the electronic control housing; and
when the two storage housings flip to a stacked state, the two charging slots are mutually covered to form a closed storage space.

Beneficial effects of the present disclosure are as follows:
1. The portability is good: in the Bluetooth earphone case according to the present disclosure, by using the design that the electronic control housing is independent of the two storage housings, in a stacked state, the storage housings are mutually folded rather than extend outwards, thereby effectively reducing an overall thickness of the case body. This design avoids an extra thickness of a conventional earphone case added by a flip cover or same-sided storage slots, so that the earphone case is more compact. Due to a mutually folded design of the storage housings, horizontal space occupied when the earphones are stored in the case body is effectively controlled, thereby reducing the width. This is particularly important for a user who needs the earphone case to be carried in a pocket or a small bag, because this design enables the earphone case to be stored and carried more easily.
2. The structure is simple: the two storage housings are mutually stacked, so that the two charging slots can be mutually covered. A flip cover structure required by a conventional Bluetooth earphone case is omitted, thereby simplifying an overall structure, and reducing a quantity and complexity of components.

### BRIEF DESCRIPTION OF THE DRAWINGS

FIG. 1 is a schematic structural diagram (in an unfolded state) of a Bluetooth earphone case according to a first embodiment of the present disclosure;

FIG. 2 is a schematic structural diagram (in a forward folding state) of a Bluetooth earphone case according to a first embodiment of the present disclosure;

FIG. 3 is a schematic structural diagram (in a backward folding state) of a Bluetooth earphone case according to a first embodiment of the present disclosure; and

FIG. 4 is an exploded view of a Bluetooth earphone case according to a first embodiment of the present disclosure.

### REFERENCE SIGNS

1: electronic control housing; 11: bottom housing; 111: wire pass-through hole; 12: top cover; 13: charging interface; 2: storage housing; 21: charging slot; 22: charging contact; 23: hinge protrusion; 231: hinge hole; 232: routing channel; 3, power supply assembly; 31: battery; 32: control circuit board; 4: hinge shaft; and 41: limit stop plate.

### DETAILED DESCRIPTION OF THE EMBODIMENTS

To describe the technical content, objectives, and effects of the present disclosure in detail, the following is described with reference to implementations and attached figures.

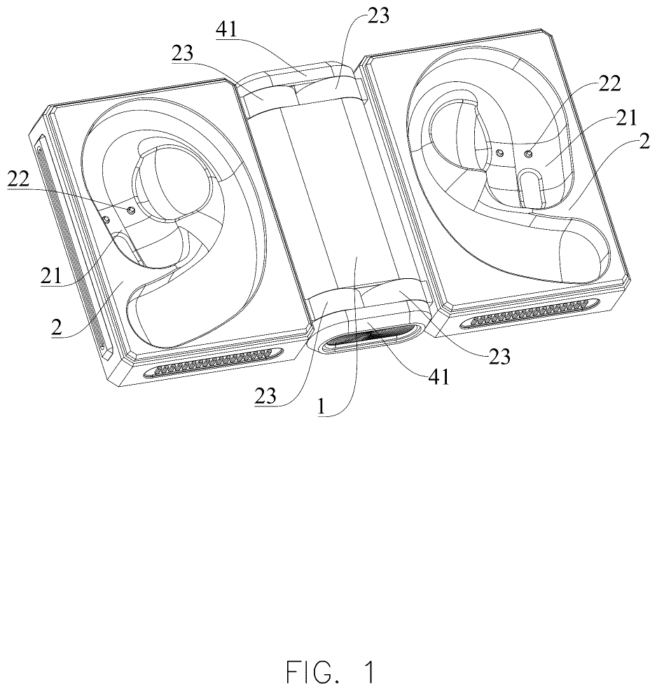

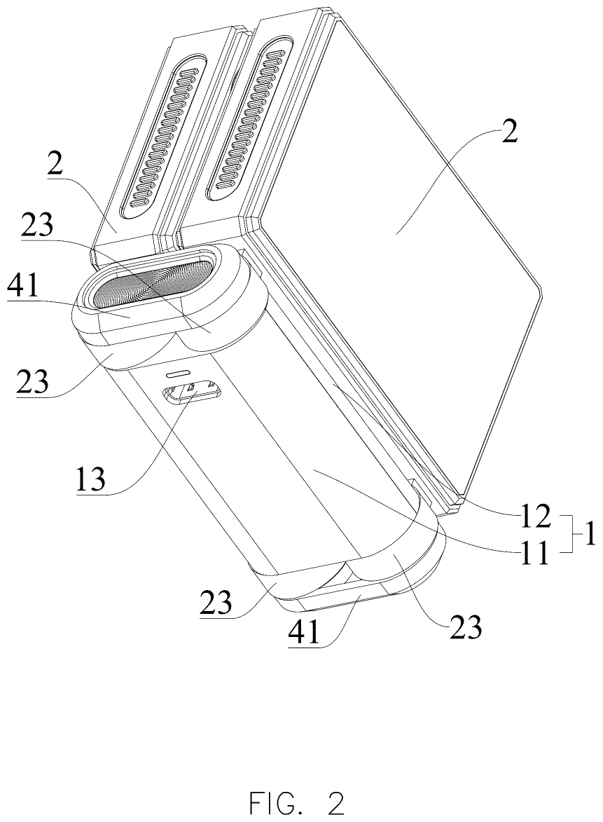

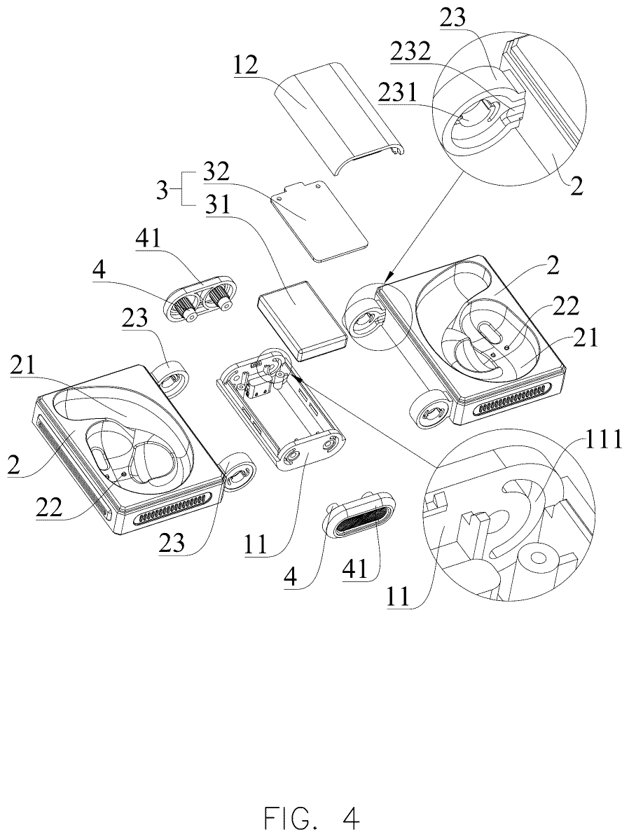

Referring to FIG. 1 to FIG. 4, a Bluetooth earphone case includes:
an electronic control housing 1, where a power supply assembly 3 is disposed in the electronic control housing 1; and
two storage housings 2, where each storage housing 2 is provided with one charging slot 21 for placing a Bluetooth earphone, and the charging slot 21 is internally provided with a charging contact 22 matched with a charging port for charging the Bluetooth earphone.

The power supply assembly 3 is electrically connected to the charging contact 22 in the charging slot 21, so as to implement charging of the Bluetooth earphone.

The two storage housings 2 are respectively hinged to the electronic control housing 1.

When the two storage housings 2 flip to a stacked state, the two charging slots 21 are mutually covered to form a closed storage space.

It may be learned from the foregoing description that the present disclosure has the following beneficial effects. By using the design that the electronic control housing 1 is independent of the two storage housings 2, in a stacked state, the storage housings 2 are mutually folded rather than extend outwards, thereby effectively reducing an overall thickness of the case body. This design avoids an extra thickness of a conventional earphone case added by a flip cover or same-sided storage slots, so that the earphone case is more compact. Due to a mutually folded design of the storage housings 2, horizontal space occupied when the earphones are stored in the case body is effectively controlled, thereby reducing the width. This is particularly important for a user who needs the earphone case to be carried in a pocket or a small bag, because this design enables the earphone case to be stored and carried more easily. The two storage housings 2 are mutually stacked, so that the two charging slots 21 can be mutually covered. A flip cover structure required by a conventional Bluetooth earphone case is omitted, thereby simplifying an overall structure, and reducing a quantity and complexity of components.

Further, a flip angle of the storage housing 2 relative to the electronic control housing 1 is within a range of 0°-180°.

It may be learned from the foregoing description that the flip angle of the storage housing 2 relative to the electronic control housing 1 is restricted to be within the range of 0°-180°, so that flexibility is provided for different usage scenarios of the earphone case.

Further, the storage housing 2 is provided with a hinge protrusion 23, and the hinge protrusion 23 is hinged to the electronic control housing 1.

It may be learned from the foregoing description that by using the design of the hinge protrusion 23, connection stability between the storage housing 2 and the electronic control housing 1 is enhanced, so that a flip action is smoother and more reliable.

Further, each of the storage housings 2 is provided with two hinge protrusions 23, and the two hinge protrusions 23 of the storage housing 2 are respectively hinged to two opposite ends of the electronic control housing 1.

It may be learned from the foregoing description that two hinge protrusions 23 are disposed on each of the storage housings 2, and are respectively hinged to two opposite ends of the electronic control housing 1, thereby providing better structural balance and stability, and ensuring balanced force of the storage housings 2 when flipping.

Further, the hinge protrusion 23 is provided with a routing channel 232 communicating with the interior of the storage housing 2, and a wire pass-through hole 111 communicating with the interior of the electronic control housing 1 is disposed at a position that is of the electronic control housing 1 and that is corresponding to the routing channel 232.

It may be learned from the foregoing description that through the design of the routing channel 232 and the wire pass-through hole 111, an electrical connection between the power supply assembly 3 and the charging contact 22 is concealed and safe, thereby avoiding bare wires, and improving an attractive appearance and durability of the integral design.

Further, the hinge protrusion 23 is provided with a hinge hole 231, and the electronic control housing 1 is provided with a hinge shaft 4 hinged to the hinge hole 231.

It may be learned from the foregoing description that the design of the hinge hole 231 and the hinge shaft 4 provides a simple and effective connection mechanism, so that the storage housing 2 can be stably connected to the electronic control housing 1, and a smooth flip action is implemented.

Further, one end that is of the hinge shaft 4 and that faces away from the electronic control housing 1 is provided with a limit stop plate, and the limit stop plate 41 abuts against one side that is of the hinge protrusion 23 and that faces away from the electronic control housing 1.

It may be learned from the foregoing description that arrangement of the limit stop plate can effectively perform axial limiting on hinge between the hinge protrusion 23 and the hinge shaft 4, thereby reducing a risk that the hinge protrusion 23 is loosened from the hinge shaft 4.

Further, a charging interface 13 electrically connected to the power supply assembly 3 is further disposed on a surface of the electronic control housing 1, and when the two storage housings 2 flip to a state in which the two charging slots 21 are mutually covered, the charging interface 13 is exposed to the electronic control housing 1.

It may be learned from the foregoing description that through an exposed design of the charging interface 13, the user can conveniently charge the power supply assembly 3 when the storage housing 2 flips to a closed state, thereby improving convenience of use.

Further, the electronic control housing 1 includes a bottom housing 11 and a top cover 12 installed on the bottom housing 11, an installation cavity is formed between the top cover 12 and the bottom housing 11, and the power supply assembly 3 is installed in the installation cavity.

It may be learned from the foregoing description that the installation cavity including the bottom housing 11 and the top cover 12 provides a protective space for the power supply assembly 3, thereby helping prevent damage to the power supply assembly 3, and facilitating maintenance and replacement.

Further, the top cover 12 is detachably connected to the bottom housing 11.

It may be learned from the foregoing description that a detachable connection between the top cover 12 and the bottom housing 11 provides a convenient maintenance and upgrade path for the user, and the power supply assembly 3 can be checked or replaced without a complex operation.

Referring to FIG. 1 to FIG. 4, a first embodiment of the present disclosure is as follows. A Bluetooth earphone case includes an electronic control housing 1 and two storage housings 2. A power supply assembly 3 is disposed in the electronic control housing 1. The two storage housings are provided with one charging slot 21 for placing a Bluetooth earphone, and the charging slot 21 is internally provided with a charging contact 22 matched with a charging port for charging the Bluetooth earphone. The power supply assembly 3 is electrically connected to the charging contact 22 in the charging slot 21, so as to implement charging of the Bluetooth earphone. The power supply assembly 3 is electrically connected to the charging contact 22 in the charging slot 21, so as to implement charging of the Bluetooth earphone. The two storage housings 2 are respectively hinged to the electronic control housing 1. When the two storage housings 2 flip to a stacked state, the two charging slots 21 are mutually covered to form a closed storage space. It may be understood that by using the design that the electronic control housing 1 is independent of the two storage housings 2, in a stacked state, the storage housings 2 are mutually folded rather than extend outwards, thereby effectively reducing an overall thickness of the case body. This design avoids an extra thickness of a conventional earphone case added by a flip cover or same-sided storage slots, so that the earphone case is more compact. Due to a mutually folded design of the storage housings 2, horizontal space occupied when the earphones are stored in the case body is effectively controlled, thereby reducing the width. This is particularly important for a user who needs the earphone case to be carried in a pocket or a small bag, because this design enables the earphone case to be stored and carried more easily. The two storage housings 2 are mutually stacked, so that the two charging slots 21 can be mutually covered. A flip cover structure required by a conventional Bluetooth earphone case is omitted, thereby simplifying an overall structure, and reducing a quantity and complexity of components.

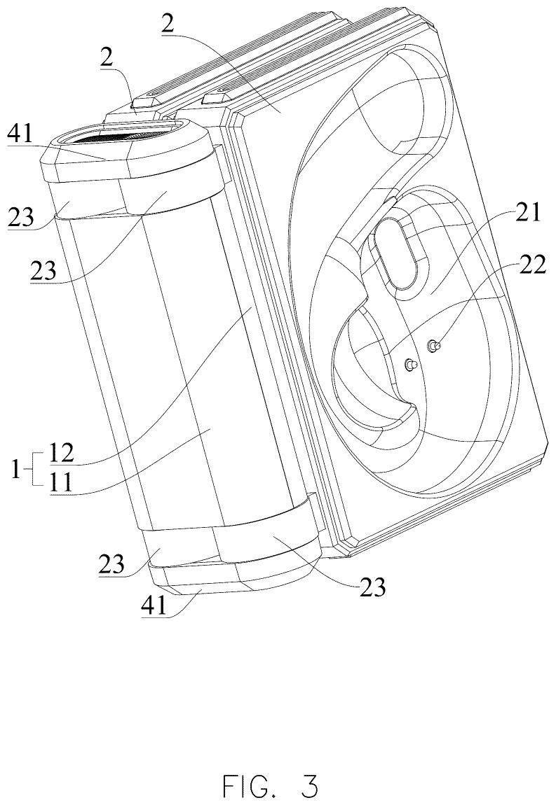

Optionally, a flip angle of the storage housing 2 relative to the electronic control housing 1 is within a range of 0°-180°. Further, a synchronous transmission structure (such as an engagement gear) may be disposed between the two storage housings 2, so that the two storage housings 2 can rotate synchronously by using the synchronous transmission structure. In this way, convenience when the Bluetooth earphone case is opened and closed can be improved, and damping can be provided for rotation of the storage housing 2. It should be noted that, in a case that a synchronous transmission structure is disposed, the flip angle of the storage housing 2 relative to the electronic control housing 1 is 45°-180°, which provides flexibility for different use scenarios of the earphone case, and ensures that the charging slot 21 can reliably cover and protect the earphone. Specifically, in this embodiment, the two storage shells 2 may flip by 180° relative to the electronic control housing 1. As shown in FIG. 3, the two storage housings 2 may be folded backward, so that the two charging slots 21 are exposed. In this state, it is convenient for the user to pick and place Bluetooth earphones, thereby enriching a use scenario of the Bluetooth earphone case.

Preferably, the storage housing 2 is provided with a hinge protrusion 23, and the hinge protrusion 23 is hinged to the electronic control housing 1. It may be understood that, by using the design of the hinge protrusion 23, connection stability between the storage housing 2 and the electronic control housing 1 is enhanced, so that a flip action is smoother and more reliable. Specifically, in this embodiment, each of the storage housings 2 has two hinge protrusions 23, and the two hinge protrusions 23 of the storage housing 2 are respectively hinged to two opposite ends of the electronic control housing 1. In this way, better structural balance and stability are provided to ensure balanced force when the storage housing 2 flips.

To avoid accidental opening of the Bluetooth earphone case in a forward folding state (that is, the charging slots 21 of the two storage housings 2 are mutually covered), the two storage housings are internally provided with a magnetic attraction member (not shown in the figure), respectively. When the two charging slots are mutually covered, the magnetic attraction members in the two storage housings are mutually attracted. By means of adsorption of the two magnetic attraction members, an adsorption force is provided for closing the two storage housings 2, thereby helping improve structural stability. Specifically, the magnetic attraction member may be a permanent magnet, and polarities of the two permanent magnets are the same. Optionally, a quantity of the magnetic attraction members and installation positions may be set according to an actual application requirement, and details are not described herein again.

In addition, in some other embodiments, the quantity of the hinge protrusions 23 on the storage housing 2 may alternatively be one. Specifically, the quantity of the hinge protrusions 23 and hinge positions of the hinge protrusions 23 and the electronic control housing 1 may be set according to an actual application requirement. Details are not described herein again.

In this embodiment, the hinge protrusion 23 is provided with a hinge hole 231, and the electronic control housing 1 is provided with a hinge shaft 4 hinged to the hinge hole 231. The design of the hinge hole 231 and the hinge shaft 4 provides a simple and effective connection mechanism, so that the storage housing 2 can be stably connected to the electronic control housing 1, and a smooth flip action is implemented. Specifically, one end that is of the hinge shaft 4 and that faces away from the electronic control housing 1 is provided with a limit stop plate, and the limit stop plate 41 abuts against one side that is of the hinge protrusion 23 and that faces away from the electronic control housing 1. In this way, axial limiting can be performed on hinge between the hinge protrusion 23 and the hinge shaft 4, thereby reducing a risk that the hinge protrusion 23 is loosened from the hinge shaft 4.

Preferably, the power supply assembly 3 includes a battery 31 and a control circuit board 32 electrically connected to the battery 31, and the control circuit board 32 is electrically connected to the charging contact in the charging slot 21 by using a conducting circuit. To ensure that the conducting circuit can effectively establish an electrical connection between the control circuit board 32 and the charging contact, a routing channel 232 communicating with the interior of the storage housing 2 is disposed in the hinge protrusion 23, and a wire pass-through hole 111 communicating with the interior of the electronic control housing 1 is disposed at a position that is of the electronic control housing 1 and that is corresponding to the routing channel 232. In this way, the electrical connection between the power supply assembly 3 and the charging contact 22 is both concealed and safe, thereby avoiding bare wires and improving overall design attractive appearance and durability. Specifically, in this embodiment, the wire pass-through hole 111 extends in a direction around a central axis of the hinge shaft 4 on the electronic control housing 1, that is, the wire pass-through hole 111 is in an arc shape. Because a flip angle of the storage housing 2 in this embodiment is 180°, the wire pass-through hole 111 is in a semi-circular arc shape. That is, an arc length of the wire pass-through hole 111 may be set based on the specific flip angle of the storage housing 2, which is not listed herein.

Preferably, a charging interface 13 electrically connected to the power supply assembly 3 is further disposed on a surface of the electronic control housing 1. When the two storage housings 2 flip to a state in which the two charging slots 21 are mutually covered, the charging interface 13 is exposed to the electronic control housing 1, and the charging interface 13 is designed to be exposed, so that when the storage housing 2 flips to a closed state, the user can conveniently charge the power supply assembly 3, thereby improving convenience of use. Specifically, the electronic control housing 1 includes a bottom housing 11 and a top cover 12 installed on the bottom housing 11. The charging interface 13 is disposed at a bottom of the bottom housing 11. An installation cavity is formed between the top cover 12 and the bottom housing 11. The power supply assembly 3 is installed in the installation cavity. The installation cavity formed by the bottom housing 11 and the top cover 12 provides a protective space for the power supply assembly 3, thereby helping prevent power supply assembly 3 from being damaged, and facilitating maintenance and replacement. More specifically, the top cover 12 is detachably connected to the bottom housing 11. It may be understood that a detachable connection between the top cover 12 and the bottom housing 11 provides a convenient maintenance and upgrade path for the user, and the power supply assembly 3 can be checked or replaced without a complex operation. The detachable connection manner includes but is not limited to one or more of a buckle connection, a screw connection, a magnetic attraction connection, and a bolt connection, and may be specifically set based on an actual application requirement.

In conclusion, in the Bluetooth earphone case according to the present disclosure, by using the design that the electronic control housing is independent of the two storage housings, in a stacked state, the storage housings are mutually folded rather than extend outwards, thereby effectively reducing an overall thickness of the case body. This design avoids an extra thickness of a conventional earphone case added by a flip cover or same-sided storage slots, so that the earphone case is more compact. Due to a mutually folded design of the storage housings, horizontal space occupied when the earphones are stored in the case body is effectively controlled, thereby reducing the width. This is particularly important for the user who needs the earphone case to be carried in a pocket or a small bag, because this design enables the earphone case to be stored and carried more easily. The two storage housings are mutually stacked, so that the two charging slots can be mutually covered. A flip cover structure required by a conventional Bluetooth earphone case is omitted, thereby simplifying an overall structure, and reducing a quantity and complexity of components.

The above are only the embodiments of the present disclosure and not intended to limit the protection scope of the present disclosure, and any equivalent transformations based on the specification and the accompanying drawings of the present disclosure, which is directly or indirectly applied in other related technical fields, shall similarly fall within the scope of patent protection of the present disclosure.

What is claimed is:

1. A Bluetooth earphone case, comprising:
an electronic control housing, wherein a power supply assembly is disposed in the electronic control housing; and
two storage housings, wherein each storage housing is provided with one charging slot for placing a Bluetooth earphone, and the charging slot is internally provided with a charging contact matched with a charging port for charging the Bluetooth earphone;
the power supply assembly is electrically connected to the charging contact in the charging slot, so as to implement charging of the Bluetooth earphone;
the two storage housings are respectively hinged to the electronic control housing; and
when the two storage housings flip to a stacked state, the two charging slots are mutually covered to form a closed storage space.

2. The Bluetooth earphone case according to claim 1, wherein a flip angle of the storage housing relative to the electronic control housing is within a range of 0°-180°.

3. The Bluetooth earphone case according to claim 1, wherein the storage housing is provided with a hinge protrusion, and the hinge protrusion is hinged to the electronic control housing.

4. The Bluetooth earphone case according to claim 3, wherein each of the storage housings is provided with two hinge protrusions, and the two hinge protrusions of the storage housing are respectively hinged to two opposite ends of the electronic control housing.

5. The Bluetooth earphone case according to claim 3, wherein the hinge protrusion is provided with a routing channel communicating with the interior of the storage housing, and a wire pass-through hole communicating with the interior of the electronic control housing is disposed at a position that is of the electronic control housing and that is corresponding to the routing channel.

6. The Bluetooth earphone case according to claim 3, wherein the hinge protrusion is provided with a hinge hole, and the electronic control housing is provided with a hinge shaft hinged to the hinge hole.

7. The Bluetooth earphone case according to claim 6, wherein one end that is of the hinge shaft and that faces away from the electronic control housing is provided with a limit stop plate, and the limit stop plate abuts against one side that is of the hinge protrusion and that faces away from the electronic control housing.

8. The Bluetooth earphone case according to claim 1, wherein a charging interface electrically connected to the power supply assembly is further disposed on a surface of the electronic control housing, and when the two storage housings flip to a state in which the two charging slots are mutually covered, the charging interface is exposed to the electronic control housing.

9. The Bluetooth earphone case according to claim 1, wherein the electronic control housing comprises a bottom housing and a top cover installed on the bottom housing, an installation cavity is formed between the top cover and the bottom housing, and the power supply assembly is installed in the installation cavity.

10. The Bluetooth earphone case according to claim 9, wherein the top cover is detachably connected to the bottom housing.

11. The Bluetooth earphone case according to claim 1, wherein the two storage housings are internally provided with a magnetic attraction member, respectively, and when the two charging slots are mutually covered, the magnetic attraction members in the two storage housings are mutually attracted.
